(19) United States
(12) Patent Application Publication
(10) Pub. No.: US 2010/0293362 A1
(43) Pub. Date: Nov. 18, 2010

(54) Portable device containing programs and user data usable on almost MAC or Windows computer

(76) Inventor: Bruce F. Brockman, North Ridgeville, OH (US)

Correspondence Address: Bruce Brockman, 8875 Harris Drive, North Ridgeville, OH, 44039-4423, US

(21) Appl. No.: 12/780,901

(22) Filed: Jul. 22, 2010

Related U.S. Application Data
(60) Provisional application No. 61/178,586, filed on May 15, 2009.

(51) Int. Cl. G06F 9/00

(52) U.S. Cl. 713/1

(57) ABSTRACT

A removable computer information storage device which is formatted for operation on a portable or stationary computer system currently operating on Apple (MAC) or IBM (Windows) software without on-board mechanical or operational software necessary for the transition of the two systems.

This application emanates from a previously filed provisional application: 61/178,586, May 15, 2009

### FIELD OF THE INVENTION

The present invention relates to a portable storage device with universal serial bus or other connectivity hereafter referred to as USB and more particularly to a portable storage device which allows immediate use on either Apple MAC or Windows based computer systems.

### BACKGROUND OF THE INVENTION

The present invention relates to a portable data storage device and more particularly to a computer readable portable data storage device, which is comprised of a main circuit board, a memory circuit board coupled to the main circuit board, and a USB port and adapted to electrically connected the main circuit board to the USB port of a personal computer.

A regular portable data storage device is readable to a computer and can be connected to the USB port of a personal computer for enabling the user to transmit data between the personal computer and the portable data storage device. When connecting a portable data storage device to the USB port of a personal computer, a major part of the portable data storage device functionality is determined by the pre-loaded or compatibility software via Apple MAC or IBM Windows, but not both.

Many computer experts have wished for such a device but the only solutions offered to date is software allowing MAC or Windows to run the other operating system. In most cases it runs virtually but just on the machine the software is installed on and at a significant cost.

### SUMMARY OF THE INVENTION

Briefly, this invention comprises a removable drive which can be formatted in such a manner to allow programs for both Mac OS X 10.4 to 10.6—Intel and PPC and Windows 2000 through 7 to be run on most any available computer. The configuration also allows for storage, retrieval or alteration of users data. The programs provided are GPL and the same basic ones for MAC and Windows. The configuration also allows for an encryption partition usable from both MAC and Windows. The use of the device leaves no “footprints” on the host computer and all private information resides on the device.

One of the primary objects of this invention is to provide a removable drive that can be formatted for use on Apple or Window based systems without format conflict.

The device consists of an external portable data storage drive that can be plugged into most Windows or Mac computers. The device must be formatted in a particular way and loaded with certain software.

The subject device has two partitions on it. Partition 1 must be a Windows partition with a FAT32 file structure, as the device is a portable device it is the only partition Windows can read. Partition 2 is in Mac format, HFS or HFS+ preferred.

Platform specific General Public License programs, like the portable Mac PPC and Intel versions of Open Office are “installed” on the Mac partition and the Windows portable version is “installed” in the Windows partition. Utilizing a Windows start menu mimic program, Codyssey, the user of this device finds the programs as they would from the Windows Start Button. Programs in Mac show up in a normal fashion for Mac users on a Mac drive that appears (as well as a Windows drive) when the device is plugged in.

As portable versions of programs tend to be small and use only the resources of the host many can be included on relatively small drives leaving large space for storage of personal data.

All user data is stored on the Windows partition as Mac is capable of reading and writing to FAT32 files. Since the same programs are used for Mac and Windows, the files are usable whether they are opened from the Mac or Windows versions that depending on the type host computer the device are plugged into.

Additionally a high level GPL encryption program is used with a device as its disk shows up as a file on the Windows partition thus making it visible and accessible from either Windows or Mac.

No footprint is left on the host computer using the programs included on the device but if the user of this device uses a native program on the host computer a GPL program can also included on the device to clean any traces of that activity.

Included software for web browsing, email and VoIP allow users of the subject invention to keep their confidential information available to them while using the resources of the host computer.

Coupled with a “no drivers required” webcam/microphone users of my device and talk for free to people anywhere in the world via included Skype software.

### BRIEF DESCRIPTION OF THE DRAWING 1/1

FIG. 1 is a typical removable drive

### DESCRIPTION OF DRAWING PARTS

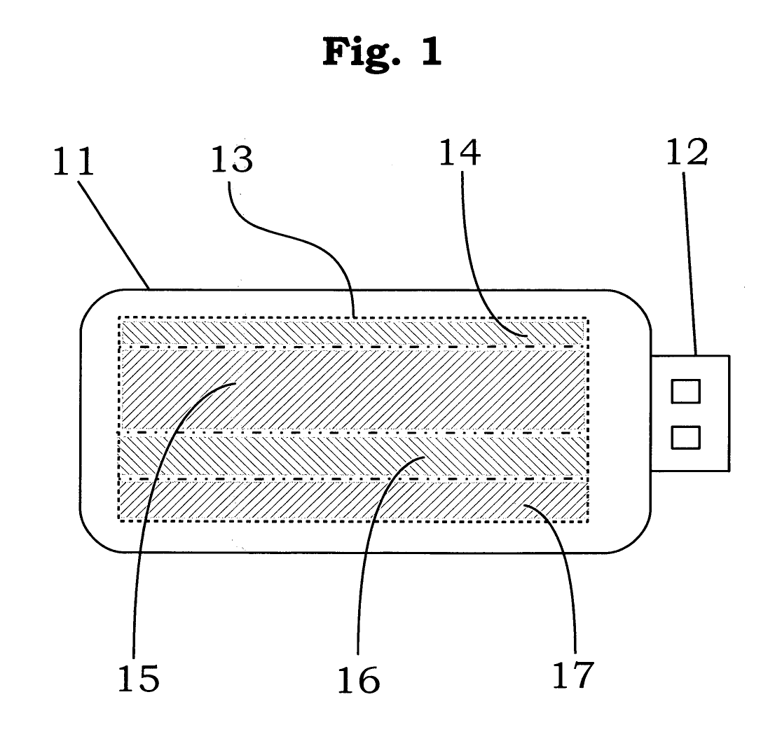

### FIG. 1 Reference Numerals

11 Body of external drive

12 Mechanical connector to interface with host computer

13 Approximate area used by external drive for memory

14 Approximate area dedicated to partition 2

15 Approximate area in partition 1 used for user data

16 Approximate area in partition 1 used for encryption area

17 Approximate area in partition 1 used for applications

### DETAILED DESCRIPTION OF THE PREFERRED EMODIMENT

An external computer storage drive FIG. 1 is capable of accessing both Apple (Macintosh) and IBM (Windows) through use of plugs 12. Within the case 11 of said device is an area dedicated to flash memory 13. In this embodiment the external storage drive is formatted in two partitions. The first partition is the space represented by 15, 16 and 17 is formatted as FAT 32. The second partition represented by 14 is formatted as HFS or HFS+. The two partition areas, 12, 16, 17 as one FAT 32 and 14 a single HFS+, during the partitioning process given a name for identification when used with Apple MAC computers. Without the specific format Windows will not be able to assign a drive letter or read the device. Once this has been accomplished the area formatted as FAT 32 can have a pseudo partition installed. This is in the form of a single large file to accommodate encryption 16. Many small files can then be securely stored within the large file 16. Specific General Public License applications written for portable devices can now be installed in the appropriate partitions. Generally like applications are nstalled for use with MAC and Windows operating systems. Once these operations have been completed the device can be plugged into Mac OS 10.4 and above or Windows 2000 and above host computers. Familiar to even novice computer users interfaces appear and the programs are presented. All user data is stored in the FAT 32 area 15 and or 16. Both MAC and Windows are capable of reading and writing to FAT 32 formatted files. All user data can be created, changed or read from either MAC or Windows. The applications are running from the device and only using the resources of the host. This makes the use of the device and it's data both portable and private.

I claim:

1. A Portable device containing programs and user data usable on almost any MAC or Windows computer which act as host to the device, comprising:
a said portable drive device is formatted in a specific manner
b said software is available and usable from both Windows and Mac host computers
c said user data is available and usable from both Windows and Mac host computers
d said host computer is capable of recognizing portable drive device
e said host computer assigns a random drive letter in Windows computers
f said host computer recognizes both partitions as drives by name in MAC computers
g said user data can remain solely on said portable drive device including but not limited to both Internet browsing and email
h said portable drive device for said user data can contain an encrypted disk in form of a file available and useable from both Windows and Mac host computers
i said portable drive device and said software use host computer physical resources
j said software is General Public License, Open Source or designated Freeware

2. A Portable device containing programs and user data usable on almost any MAC or Windows computer wherein information and/or data can be moved onto or off of without mechanical aids.

3. A Portable device containing programs and user data usable on almost MAC or Windows computer in accordance to claim 1 wherein a USB or other compatible connective port male or female is located on the device.

4. A Portable device containing programs and user data usable on almost MAC or Windows computer in accordance to claim 1 wherein software is preloaded.
